(19) United States
(12) Patent Application Publication
(10) Pub. No.: US 2005/0116707 A1
(43) Pub. Date: Jun. 2, 2005

(54) Encoder structure

(76) Inventor: Yasuaki Matsumoto, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/994,266

(22) Filed: Nov. 23, 2004

(30) Foreign Application Priority Data
Nov. 28, 2003 (JP) 2003-398986

(51) Int. Cl. G01B 7/30

(52) U.S. Cl. 324/207.25

(57) ABSTRACT

An encoder structure includes a sensor head unit 6 installed in an irrotational part, a rotative magnetic ring unit 4 that is positioned close to the sensor head unit 6 and has a north pole and a south pole arranged alternately on a circumference thereof, and a groove unit 7 formed in at least one of spaces between the north pole and the south pole located on a surface of the magnetic ring unit 4. Thus, deposits such as iron particles are easily drained away with muddy water because a part where the iron particles tend to be accumulated along a magnetic flux functions as a groove-like path. Additionally, accumulated iron particles remain inside the groove unit 7 that is concave shaped. Accordingly, prevention of damage to the sensor head unit 6 is achieved.

### BACKGROUND OF THE INVENTION

1. Field of the Invention

The present invention relates to an encoder structure that is positioned close to a sensor head unit installed in an irrotational part with a rotative magnetic ring unit of which circumference has north and south poles arranged alternately. The present invention is applied particularly to an encoder that is utilized as a sensor installed in a wheel speed detecting device of an automobile ABS (Anti Lock Brake System) and functions as a sealing device for a shaft bearing part.

2. Description of the Related Art

There has been widely used a device for detecting a magnetic force alteration associated with relative rotation of an encoder and a sensor head unit, as a wheel speed detecting device of an automobile ABS. The encoder or a magnetic material is attached to a rotational part such as a drive shaft and a bearing and is positioned close to the sensor head unit installed in their rotational part such as a wheel housing. A typical encoder is disclosed in the JP-A-2003-35565 (See paragraphs 0015 and 0016).

The encoder disclosed in the JP-A-2003-35565 will be described with reference to FIG. 8. As shown in FIGS. 8A and 8C, a magnetic encoder 110 is placed in a face-to-face position close to a magnetic sensor 115 installed in an irrotational part, and is equipped with a ring-shaped component 111 made from metal and a magnetic component 114 placed along a circumferential direction on a surface of the ring-shaped component 111. Here, as shown in FIG. 8B, the magnetic component 114 is a film of synthetic resin coating laced with magnetic powders and forms magnetic N and S poles arranged alternately by becoming multipolarized in the circumferential direction. The magnetic encoder 110 and the magnetic sensor 115 together comprise a rotation detecting device 120 as shown in FIG. 8C. On the other hand, a sealing device 105 comprises the magnetic encoder 110 and a sealing component 109 of the irrotational part.

This encoder structure has provided a magnetic encoder, which is thin, highly abrasion-resistant and highly productive, as the rotation detecting device of a wheel shaft bearing. However, in such an encoder structure, it is inevitable that small iron particles adhere to a surface of the encoder as seen in a part C of FIG. 9 in a circumstance in which the encoder is used as a suspension unit, because the encoder is a magnetic material per se. Further, deposits of the iron particles tend to be accumulated after a prolonged use. The deposits grow especially along a magnetic flux between the N and S poles. Consequently, a minute clearance between the magnetic component (a magnetic ring unit) and the magnetic sensor (a sensor head unit) is filled with the deposits that may damage the magnetic component and the magnetic sensor.

### SUMMARY OF THE INVENTION

For resolving the problems of existing encoder structures, the present invention has an object to provide an encoder structure that ensures durability and reliability of an encoder by eliminating deposits and reducing damages to the surface of the encoder and a sensor head unit.

In order to solve such problems, the present invention provides an encoder structure including a sensor head unit installed in an irrotational part, a rotative magnetic ring unit positioned close to the sensor head unit and has a north pole and a south pole arranged alternately on a circumference thereof, and a groove unit formed in at least one of spaces between the north pole and the south pole located on a surface of the magnetic ring unit. It is preferred in the present invention that a cross-sectional shape of the groove unit is selected from one of a V shape, a concave shape, a trapezoid and a horseshoe shape. Additionally, it is preferred in the present invention that a circumferentially extending groove is formed adjacently to a bottom of the groove unit to have a key-shaped groove unit. Additionally, it is preferred in the present invention that an arrangement of the north pole and the south pole on the circumference is tilted at a predetermined angle with respect to a radial line from a center of the magnetic ring unit. Further, it is preferred in the present invention that the groove unit is formed so that a direction to divide the north pole and the south pole in a cross-sectional direction of the groove unit is tilted at a predetermined angle with respect to a direction perpendicular to the surface of the magnetic ring unit.

### BRIEF DESCRIPTION OF THE DRAWINGS

FIGS. 1A, 1B and 1C are a lateral diagram showing a main part, an enlarged cross-sectional diagram showing a magnetic ring unit and a diagram showing the relation between a sensor head unit and the magnetic ring unit respectively, regarding the first embodiment of an encoder structure according to the present invention;

FIGS. 2A and 2B are an overall cross-sectional diagram showing an axis arm to which the encoder structure is adopted and an enlarged diagram showing a part B of FIG. 2A respectively, regarding the first embodiment of the encoder structure according to the present invention;

FIG. 3 is a perspective diagram showing a bearing to which the encoder structure is adopted, regarding the first embodiment of the encoder structure according to the present invention;

FIG. 4 is an enlarged cross-sectional diagram that shows a magnetic ring unit regarding the second embodiment of the encoder structure according to the present invention;

FIG. 5 is an enlarged cross-sectional diagram that shows a magnetic ring unit regarding the third embodiment of the encoder structure according to the present invention;

FIG. 6 is a lateral diagram that shows a main part regarding the fourth embodiment of the encoder structure according to the present invention;

FIG. 7 is an enlarged cross-sectional diagram that shows a magnetic ring unit regarding the fifth embodiment of the encoder structure according to the present invention;

FIG. 8 is an explanatory diagram showing a conventional magnetic encoder for an automobile; and

FIG. 9 is an explanatory diagram showing a problem regarding the conventional magnetic encoder.

### DESCRIPTION OF PREFERRED EMBODIMENTS

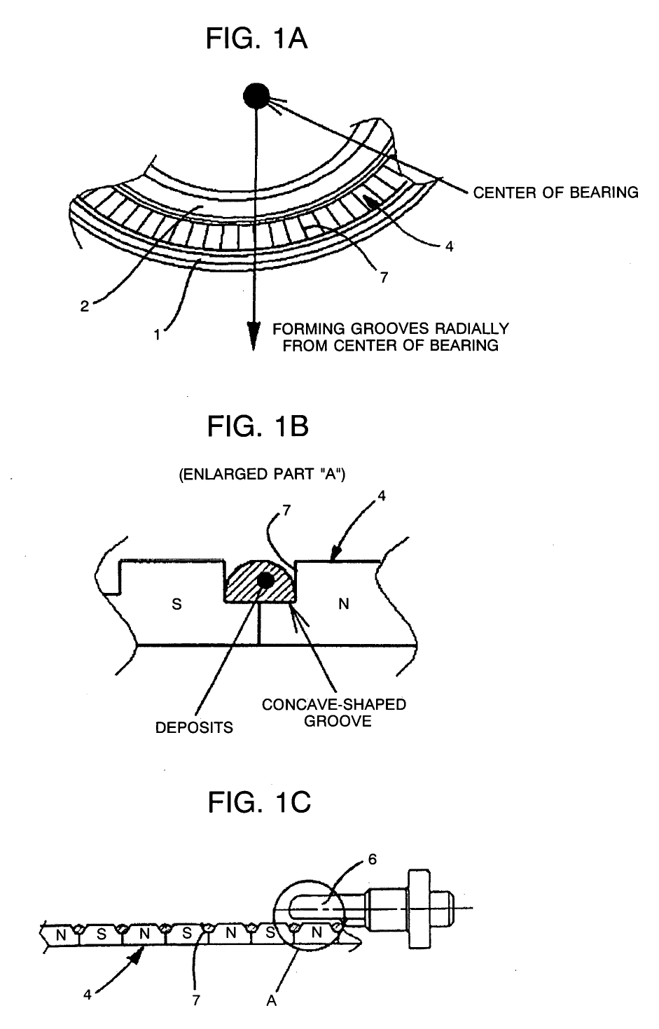

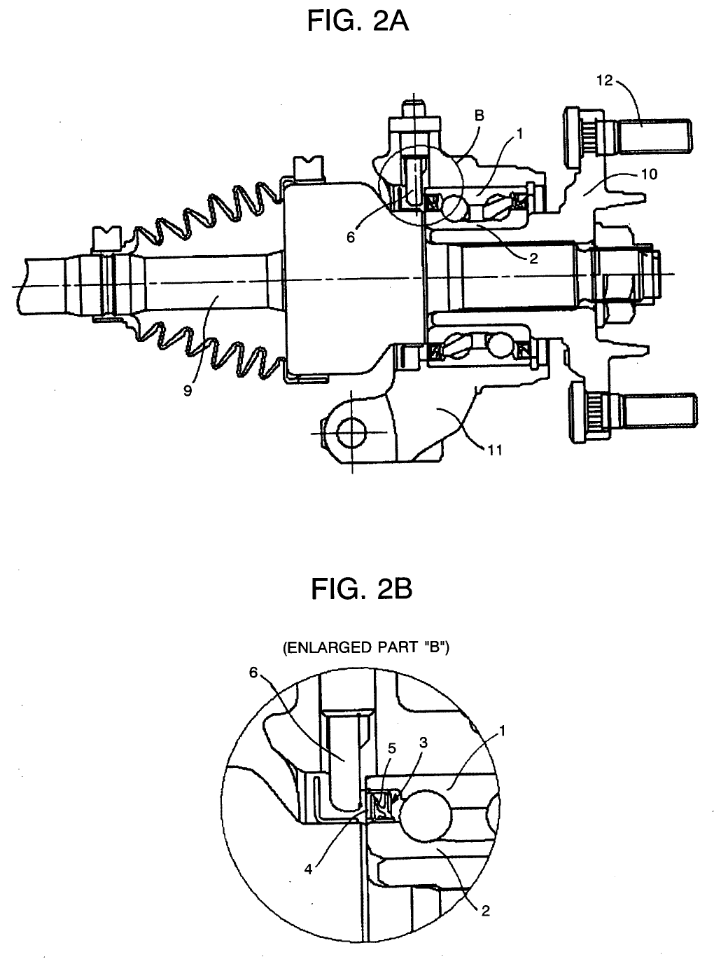

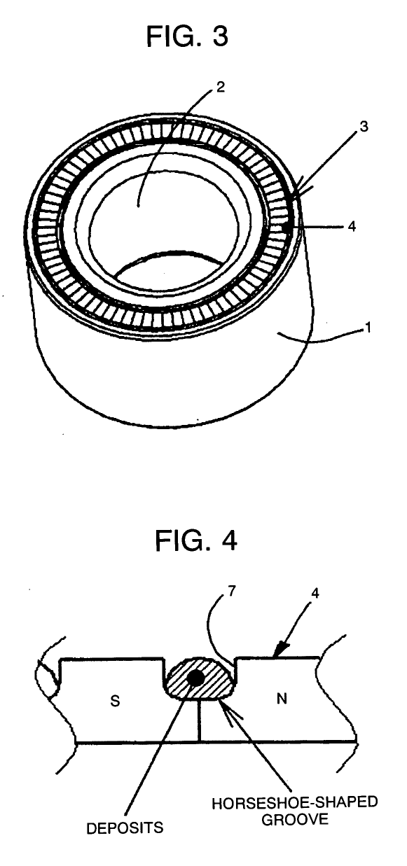

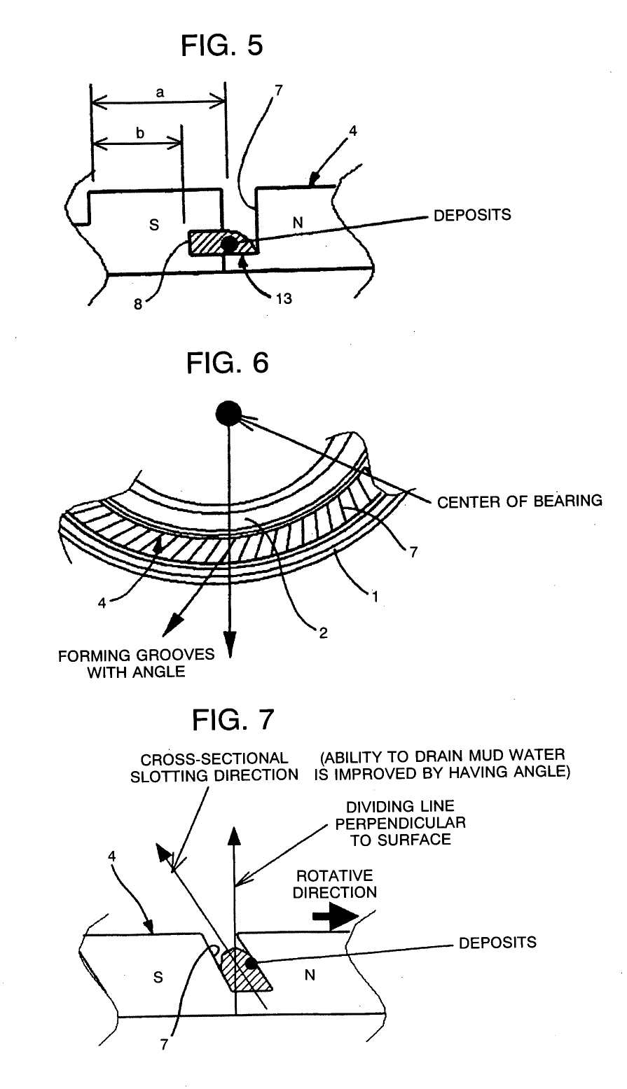

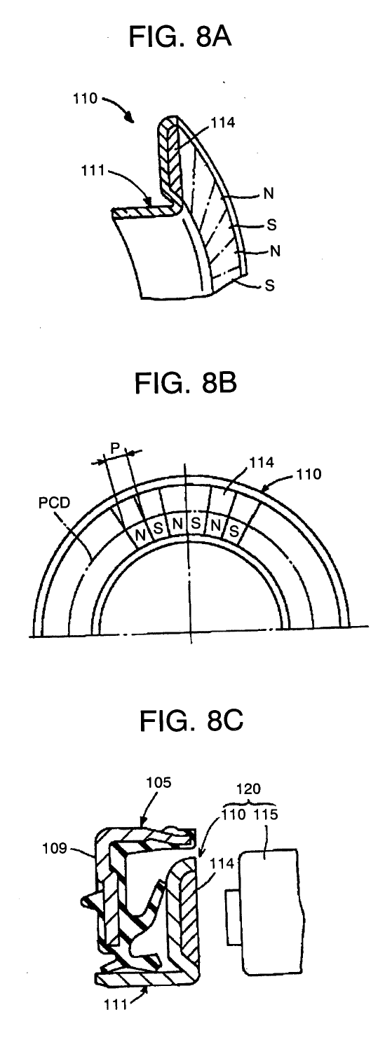

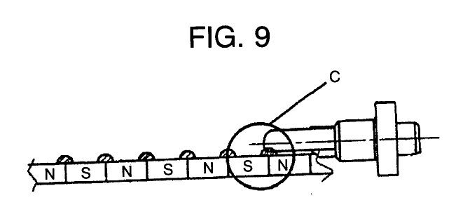

Hereinafter, preferred embodiments of the present invention will be described with reference to the drawings. FIGS. 1 to 3 show the first embodiment of the encoder structure according to the present invention. FIGS. 1A, 1B and 1C are a lateral diagram showing a main part, an enlarged cross-sectional diagram showing a magnetic ring unit and a diagram showing the relation between a sensor head unit and the magnetic ring unit respectively. FIGS. 2A and 2B are an overall cross-sectional diagram showing an axis arm to which the encoder structure according to the present invention is adopted and an enlarged diagram showing a part B of FIG. 2A respectively. FIG. 3 is a perspective diagram showing a bearing to which the encoder structure according to the present invention is adopted. FIG. 4 is an enlarged cross-sectional diagram that shows a magnetic ring unit regarding the second embodiment of the encoder structure according to the present invention. FIG. 5 is an enlarged cross-sectional diagram that shows a magnetic ring unit regarding the third embodiment of the encoder structure according to the present invention. FIG. 6 is a lateral diagram that shows a main part regarding the fourth embodiment of the encoder structure according to the present invention. FIG. 7 is an enlarged cross-sectional diagram that shows a magnetic ring unit regarding the fifth embodiment of the encoder structure according to the present invention.

As shown in FIG. 1, a basic configuration of the encoder structure according to the present invention includes a rotative magnetic ring unit 4 that is positioned close to a sensor head unit 6 installed in an irrotational part and has N and S poles arranged alternately on the circumference. Such an encoder structure is characterized by forming a groove unit 7 in at least one of spaces between the N and S poles located on the surface of the magnetic ring unit 4.

### First Embodiment

A description will be now given of the first embodiment of the present invention. As Shown in FIG. 2, an encoder 3 according to the present invention is adopted to a sealing device for a bearing of a shaft. However, the adoption of the encoder 3 is not limited to the shaft, and is allowed to other parts where hermetically sealing is necessary and rotational and irrotational parts are close to each other. As shown in FIG. 2A, a wheel hub 10 is supported in an axial direction against a wheel housing 11, that is, the irrotational part fixed to a vehicle body, by the bearing comprising an outer ring 1 and an inner ring 2 together holding balls therebetween. One end of a drive shaft 9 is combined with an inner side of the wheel hub 10 by a spline connection. A reference number “12” indicates a hub nut fixed to the wheel hub 10 and locks a wheel disk.

The encoder 3 according to the present invention is positioned between one end of the outer ring 1 and the corresponding end of the inner ring 2 that are rotating relatively to each other, as shown in FIG. 2B or the enlarged diagram showing the part B of FIG. 2A. The encoder 3 comprises L-shaped retainers, each being fixed to the outer ring 1 and the inner ring 2 and positioned to face each other, in addition to a sealing unit 5 and the magnetic ring unit 4 fixed to each L-shaped retainer. In the present embodiment, the sealing unit 5 is positioned on the irrotational side, where the magnetic ring unit 4 is positioned on the rotational side. The sensor head unit 6 such as an ABS sensor mounted on the irrotational side of the wheel housing 11 is located close to the surface of the magnetic ring unit 4.

FIG. 3 shows the encoder structure installed in a bearing device. The encoder 3 exposing the magnetic ring unit 4 is mounted at an end of spaces between the outer ring 1 and the inner ring 2 of the bearing device. FIG. 1A is the enlarged lateral diagram showing the main part of FIG. 3, where the magnetic ring unit 4 comprises numbers of the N and S poles arranged alternately. In the present embodiment, the arrangement of the N and S poles corresponds to radial lines from the center of the magnetic ring unit 4. In other words, a borderline between a N pole and a S pole is identical to a radial line from the center. The groove unit 7 is formed on each of the borderlines between the N and S poles as shown in FIG. 1B in the present invention. The groove unit 7 is formed as a concave shaped groove of which cross-section is square-shaped in the present embodiment. This groove unit 7 is preferably formed on each border as shown in FIG. 1C. However, formation of the groove unit 7 on all borders is unnecessary if accumulation of the iron particles or the like in the groove units 7 formed on some borders reduces a relative amount of deposits such as the iron particles on the other borders without groove unit 7, that is, if an interference by the deposits is inhibited in practical usage.

According to the composition of the present embodiment, even if the iron particles or the like adhere along a magnetic flux inside the groove unit 7 that is formed on the borderline between the N and S pole located on the surface of the magnetic ring unit 4, the iron particles or the like are easily drained away with flowing down muddy water by a gutter-like effect of the groove unit 7. Such effect is enhanced with a centrifugal force of a rotating wheel. Additionally, the deposits accumulated inside the groove unit 7 can be effectively eliminated with the muddy water while the wheel is rotating according to a waterwheel-like effect caused by an edge of a sidewall of the groove unit 7. Further, the groove unit 7 can maintain a clearance between the surface of the magnetic ring unit 4 and the sensor head unit 6 for an extended period of time because of the large capacity for the deposits, even if the iron particles or the like are accumulated inside the groove unit 7 after a long term operation. Accordingly, prevention of damaging the sensor head unit 6 is achieved, and thus, maintenance of detection precision of the sensor head unit 6 as a detecting device is ensured.

### Second Embodiment

FIG. 4 is the enlarged cross-sectional diagram showing the magnetic ring unit 4 regarding the second embodiment of the encoder structure according to the present invention. In the present embodiment, the groove unit 7 is formed so that the cross section of the groove unit 7 is shaped like a horseshoe. Since the groove unit 7 has a circular configuration especially at its bottom corner by forming the cross-sectional shape of the groove unit 7 to a horseshoe shape, the deposits are hardly accumulated at the bottom corner. Additionally, the capacity of the groove unit 7 for the deposits can be determined by selecting the cross-sectional shape of the groove unit 7 from a V shape, a trapezoid, a half-arc shape or the like. Meanwhile, the durability of each magnetic ring unit 4 is ensured according to the shape-related characteristics based on the relation between the strength and durability of the magnetic ring unit 4 regarding formation of the groove unit 7.

### Third Embodiment

FIG. 5 is the enlarged cross-sectional diagram showing the magnetic ring unit 4 regarding the third embodiment of the encoder structure according to the present invention. In the present embodiment, a circumferentially extending groove 8 is formed adjacently to the bottom of the groove unit 7 to have a key-shaped groove unit 13. Normally, the groove unit 7 is supposed to be formed so that the surface area of the magnetic ring unit 4 becomes an area “b”. However, formation of the groove 8 secures the relatively large surface area “a” of the magnetic ring unit 4 and the large capacity for the deposits at the same time (a>b). According to the third embodiment, the magnetic ring unit 4 can secure the relatively large surface area to acquire a high magnetic characteristic in spite of having the groove unit 7 and the groove 8. In addition, the gutter-like effect caused by the centrifugal force of a rotating wheel and a water-spitting-out effect caused by the waterwheel-like effect together enable easy elimination of the deposits inside the groove unit 7 and the groove 8 with the muddy water to reduce damage to the other parts.

### Fourth Embodiment

FIG. 6 is the enlarged lateral diagram showing the main part of the magnetic ring unit 4 regarding the fourth embodiment of the encoder structure according to the present invention. In the present embodiment, the magnetic ring unit 4 is so structured that the arrangement of the N and S poles on the circumference is tilted at a predetermined angle with respect to radial lines from the center of the magnetic ring unit 4. Therefore, the borderlines between the N and S poles are tilted at the predetermined angle with respect to the radial lines, causing to form the groove unit 7 tilted at the predetermined angle with respect to the radial line. Accordingly, detection impulse by the sensor head unit 6 is reduced by making alteration of the magnetic poles smooth during the detection. Additionally, the capacity for the deposits is increased by enlarging the length of the groove unit 7. Further, a draining ability of the groove unit 7 during mud water immersion is enhanced since a smooth flow of the mud water is achieved inside the groove unit 7 tilted toward a rotative direction of the magnetic ring unit 4.

### Fifth Embodiment

FIG. 7 is the enlarged cross-sectional diagram showing the magnetic ring unit 4 regarding the fifth embodiment of the encoder structure according to the present invention. The present embodiment is characterized by forming the groove unit 7 so that a direction to divide the N pole and the S pole in the cross-sectional direction of the groove unit 7 is tilted at a predetermined angle with respect to a direction perpendicular to the surface of the magnetic ring unit 4. The groove unit 7 of the encoder is tilted toward a slotting direction, that is, a direction in which the deposits are eliminated by the rotation of the magnetic ring unit 4, by forming the groove unit 7 with some angle. Consequently, the ability of the groove unit 7 to drain the mud water is further improved, preventing the accumulation of the iron particles or the like inside the groove unit 7. The borderline between the N and S poles where the groove unit 7 is formed with the cross-section being tilted according to the present embodiment may correspond to the radial line from the center of the magnetic ring unit 4 as shown in FIG. 3. Alternatively, this borderline may be tilted at a predetermined angle with respect to the radial line as shown in FIG. 6.

The description has been given of each embodiment according to the present invention, in which a shape and a type of the following items may be arbitrarily selected without departing from the principle of the present invention. Such items are, for instance, usage of the encoder (an ABS sensor, a traction control system sensor, a speedometer, etc), the shape and the type (a reed switch, etc) of the sensor head unit 6, the shape and the type of the magnetic ring unit 4 of the encoder. Others are the shape (a V shape, a concave shape, a trapezoid, a horseshoe shape, an arc shape, a tilt angle, etc), the type and a forming position of the groove unit 7 located between the N and S poles, the tilt angle of the arrangement of the N and S poles and the shape and the type (the shape of a contact lip part, a material, the shape of the L-shaped retainer, etc) of the sealing unit 5 of the encoder. Here, regarding the forming position of the groove unit 7, the groove unit 7 may be formed to have an equal groove width on the N pole side and the S pole side of the borderline. Alternatively, the groove unit 7 may be so formed that one side of the borderline has a larger groove width than the other side. In addition, the circumferentially extending groove 8 of the key-shaped groove unit 13 may be formed on one side of the borderline. Alternatively, the circumferentially extending groove 8 may be formed on both sides of the borderline so that an actual shape of the key-shaped groove unit 13 becomes convex.

According to the present invention, the encoder structure includes the sensor head unit 6 installed in the irrotational part, the rotative magnetic ring unit 4 that is positioned close to the sensor head unit 6 and has the N and S poles arranged alternately on a circumference thereof, and the groove unit 7 formed in at least one of spaces between the N and S poles located on the surface of the magnetic ring unit 4. Thus, deposits such as the iron particles are easily drained away with the muddy water because a part along a magnetic flux where the iron particles tend to be accumulated functions as a groove-like path. Additionally, accumulated iron particles remain inside the groove unit 7 that is concave shaped. Accordingly, the deposits hardly remain on the surface of the magnetic ring unit 4, preventing from damaging the sensor head unit 6.

In a case that the cross-sectional shape of the groove unit 7 is selected from one of the V shape, the concave shape, the trapezoid and the horseshoe shape, the capacity of the groove unit 7 for the deposits is adjusted by selecting an appropriate shape of the groove unit 7 corresponding to characteristics of the magnetic ring unit 6. Accordingly, durability of the magnetic ring unit 6 is ensured according to the shape-related characteristics. Further, in a case that the circumferentially extending groove 6 is formed adjacently to the bottom of the groove unit 7 to have the key-shaped groove unit 13, a relatively large surface area of the encoder is secured to acquire the high magnetic characteristic in spite of having the groove unit 7. Additionally, the centrifugal force of the rotating wheel easily removes the deposits inside the groove unit 7, for preventing damage to other parts.

Furthermore, in a case that an arrangement of the N and S poles on the circumference is tilted at a predetermined angle with respect to a radial line from the center of the magnetic ring unit 4, detection impulse by the sensor head unit 6 can reduced by making alteration of the magnetic poles smooth. Additionally, the capacity for the deposits is increased by enlarging the length of the groove unit 7. Further, a draining ability of the groove unit 7 during the mud water immersion is enhanced since the smooth flow of the mud water is achieved inside the groove unit 7 tilted toward a rotative direction of the encoder. In a case that the groove unit 7 is formed so that the direction to divide the N and S poles in the cross-sectional direction of the groove unit 7 is tilted at the predetermined angle with respect to the direction perpendicular to the surface of the magnetic ring unit 4, an ability of the groove unit 7 to drain the mud water is further improved according to the cross-section of the groove unit 7 being tilted toward a slotting direction.

While the present invention has been disclosed in terms of the preferred embodiments in order to facilitate better understandings of the present invention, it should be appreciated that the invention can be embodied in various ways without departing from the principle of the invention. Therefore, the invention should be understood to include all possible embodiments which can be embodied without departing from the principle of the invention set out in the appended claims.

Additionally, the disclosure of Japanese Patent Application No. 2003-398986 filed on Nov. 28, 2003 including the specification, drawing and abstract is incorporated herein by reference in its entirety.

1. An encoder structure comprising:
a sensor head unit installed in an irrotational part;
a rotative magnetic ring unit positioned close to the sensor head unit and has a north pole and a south pole arranged alternately on a circumference thereof; and
a groove unit formed in at least one of spaces between the north pole and the south pole located on a surface of the magnetic ring unit.

2. The encoder structure according to claim 1 wherein,
a cross-sectional shape of the groove unit is selected from one of a V shape, a concave shape, a trapezoid and a horseshoe shape.

3. The encoder structure according to claim 2 wherein,
a circumferentially extending groove is formed adjacently to a bottom of the groove unit to have a key-shaped groove unit.

4. The encoder structure according to claim 2 wherein,
an arrangement of the north pole and the south pole on the circumference is tilted at a predetermined angle with respect to a radial line from a center of the magnetic ring unit.

5. The encoder structure according to claim 4 wherein,
the groove unit is formed so that a direction to divide the north pole and the south pole in a cross-sectional direction of the groove unit is tilted at a predetermined angle with respect to a direction perpendicular to the surface of the magnetic ring unit.

6. The encoder structure according to claim 2 wherein,
the groove unit is formed so that a direction to divide the north pole and the south pole in a cross-sectional direction of the groove unit is tilted at a predetermined angle with respect to a direction perpendicular to the surface of the magnetic ring unit.

7. The encoder structure according to claim 1 wherein,
a circumferentially extending groove is formed adjacently to a bottom of the groove unit to have a key-shaped groove unit.

8. The encoder structure according to claim 1 wherein,
an arrangement of the north pole and the south pole on the circumference is tilted at a predetermined angle with respect to a radial line from a center of the magnetic ring unit.

9. The encoder structure according to claim 8 wherein,
the groove unit is formed so that a direction to divide the north pole and the south pole in a cross-sectional direction of the groove unit is tilted at a predetermined angle with respect to a direction perpendicular to the surface of the magnetic ring unit.

10. The encoder structure according to claim 1 wherein,
the groove unit is formed so that a direction to divide the north pole and the south pole in a cross-sectional direction of the groove unit is tilted at a predetermined angle with respect to a direction perpendicular to the surface of the magnetic ring unit.
